(19) United States
(12) Patent Application Publication
(10) Pub. No.: US 2010/0243918 A1
(43) Pub. Date: Sep. 30, 2010

(54) Garnet UV phosphor and scintillator materials preparation and use in radiation detection

(75) Inventors: Nerine J. Cherepy, Oakland, CA (US); Derrick T. Speaks, Berkeley, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(73) Assignee: The Regents of the University of California

(21) Appl. No.: 11/445,569

(22) Filed: Jun. 2, 2006

(51) Int. Cl. G01T 1/20; G01T 7/00

(52) U.S. Cl. 250/484.2; 250/362; 250/473.1

(57) ABSTRACT

A method of detecting radiological substances on a surface comprises coating the surface with a coating containing an indicator material that produces UV emissions and monitoring the coating to detect the radiological substances. A UV viewer can be used for monitoring the coating to detect the radiological substances. The invention also provides a coating that includes an indicator material carried by the coating that provides an indication of the radiological substances.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to radiation detection and more particularly to materials such as garnet and other solar blind UV phosphor and scintillator materials and use of these materials in radiation detection.

2. State of Technology

U.S. Pat. No. 6,358,441 issued Mar. 19, 2002 to Steven Jude Duclos and Alok Mani Srivastava for cubic garnet host with Pr³⁺ activator as a scintillator material provides the following state of technology information: “A luminescent material absorbs exciting energy of one type, and then emits electromagnetic energy. If the exciting energy is electromagnetic radiation, the luminescent material will absorb the exciting electromagnetic energy in one region of the electromagnetic spectrum and generally will emit energy in another region of the electromagnetic spectrum. A luminescent material in powder form is called a phosphor, while a luminescent material in the form of a transparent solid body is called a scintillator.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a method of detecting radiological substances on a surface. The method comprises coating the surface with a coating containing an indicator material that produces UV emissions and monitoring the coating to detect the radiological substances. In one embodiment the present invention utilizes a solar blind detector for monitoring the coating to detect the radiological substances. In one embodiment the present invention utilizes a UV viewer for monitoring the coating to detect the radiological substances. The present invention also provides a coating for a surface for the detection of radiological substances. In one embodiment the coating includes an indicator material carried by the coating that provides an indication of the radiological substances. In one embodiment the indicator material includes LuAG doped with Scandium.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates one embodiment of a system of the present invention.

FIG. 2 is a graph that illustrates the radioluminescence spectra of LuAG:Sc and LuAG:Gd, in comparison to the solar spectrum.

FIG. 3 is a flow chart illustrating an embodiment of a synthetic approach for garnet nanocrystals useful for the present invention.

FIG. 4 is a flow chart illustrating another embodiment of a synthetic approach for garnet nanocrystals useful for the present invention.

FIG. 5 is an electron micrograph of Scandium-doped Lutetium Aluminum Garnet nanocrystals.

FIG. 6 is an electron micrograph of undoped Lutetium Aluminum Garnet nanocrystals.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

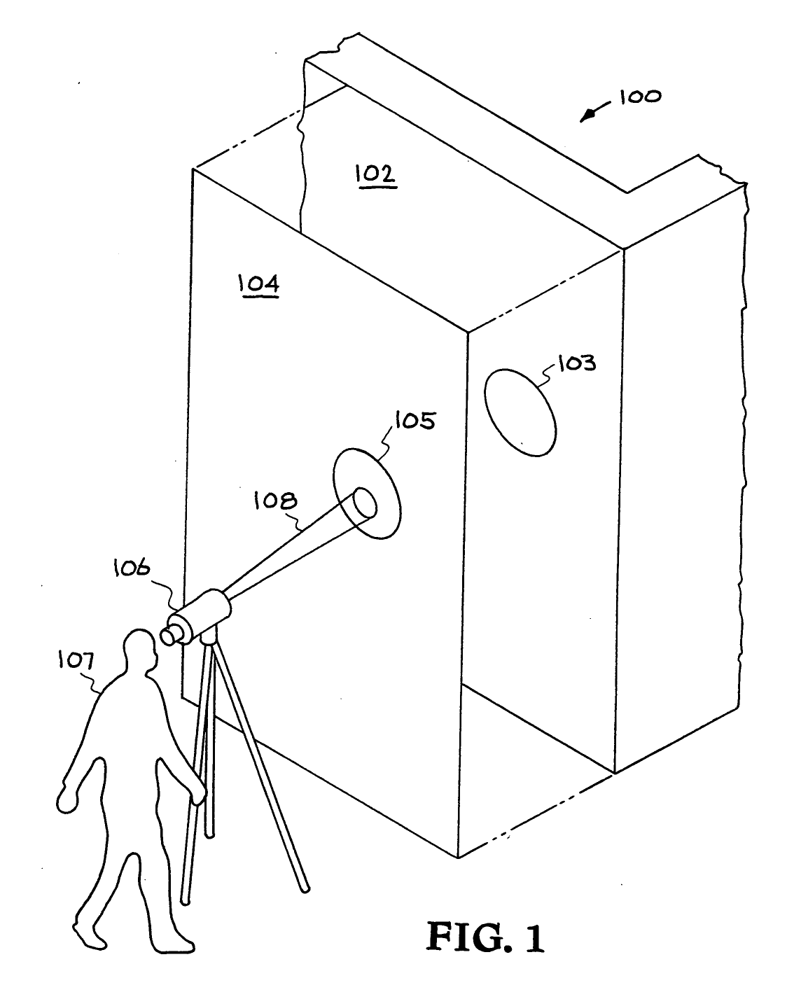

Referring to the drawings and in particular to FIG. 1, one embodiment of a system of the present invention is illustrated. This embodiment of the invention is designated generally by the reference numeral 100. The system 100 provides a coating 104 containing phosphor/scintillator particles. The coating 104 is applied over a surface 102. The surface 102 has an alpha or beta radioactively contaminated area 103. Alpha or beta radiation from the contaminated area 103 strikes the phosphor/scintillator particles in the coating 104 causing UV emissions. The UV emissions forming the area 105 are detected using a UV viewer 106. In this way, the exact location, the boundaries, and relative contamination level may be assessed and an optical image of the relative surface contamination may be recorded. This will lead to more rapid assessment and cleanup, as well as very useful validation of surface activity levels.

As illustrated in FIG. 1, a wall 101 has a surface 102. The surface 102 has been alpha or beta radioactively contaminated. Clean-up procedures have been implemented to remove the alpha or beta radioactively contaminated materials from the surface. The clean-up procedures have left radioactively contaminated materials in an area 103 and the area 103 is contaminated by alpha or beta radioactively contaminated materials.

It is difficult to locate the contaminated area 103. It is also difficult to locate the boundaries of the contaminated area 103. The system 100 comprises coating the surface 102 with the coating 104. Throughout this application the term “coating” is used in a broad sense and includes paint, powder, and other types of coatings. The coating 104 contains indicator materials. The indicator material used in the system 100 comprise garnet UV phosphor or other solar blind emitting phosphor or scintillator materials. Some examples of other solar blind materials include Barium Fluoride (BaF₂), Calcium Silicate (CaSiO₃:Pr³⁺,Gd³⁺), “BAM” (BaMg₂Al₁₆O₂₇:Tl⁺), and Lutetium Aluminum Garnet, (LuAG:Sc³⁺).

The UV phosphor or scintillator materials in the coating 104 produce emissions corresponding to the location of the contaminated area 103. The UV phosphor or scintillator materials have luminescence in the 200-280 nm range. The emissions are monitored using a UV viewer 106. The emissions produced by the garnet UV phosphor or scintillator materials provide an image of an area 105 and the image of the area 105 corresponds to the alpha or beta radioactively contaminated area 103.

As shown in FIG. 1, an individual 107 is monitoring the coating 104 for emissions produced by the UV phosphor or scintillator materials in the coating 104. The field of view 108 of the UV viewer 106 is shown focusing on the area 105 corresponding to the contaminated area 103. The emissions produced by the UV phosphor or scintillator materials provide an image of an area 105 and the image of the area 105 corresponds to the alpha or beta radioactively contaminated area 103.

As shown in FIG. 1 the system 100 illustrates that UV emission from the area 105 corresponding to the contaminated area 103 can be detected using the UV viewer 106. In this way, the exact location, the boundaries, and the relative contamination level of the contaminated area 103 can be assessed. An optical image of the relative surface contamination can be recorded. This will lead to more rapid assessment and cleanup, as well as very useful validation of surface activity levels.

The coating 104 and the indicator materials in the coating 104 will now be considered in greater detail. UV scintillation is used in the coating 104 for detection of dispersed radiological contamination. In combination with ‘solar blind’ imaging detectors, location and activity levels may be rapidly assessed. Due to ambient background light, detection of luminescent signals in the visible range is difficult. In contrast, in the ‘solar blind’ region solar irradiance is many orders of magnitude lower than in the visible, resulting in a greatly improved signal-to-noise ratio for UV scintillating detection coatings.

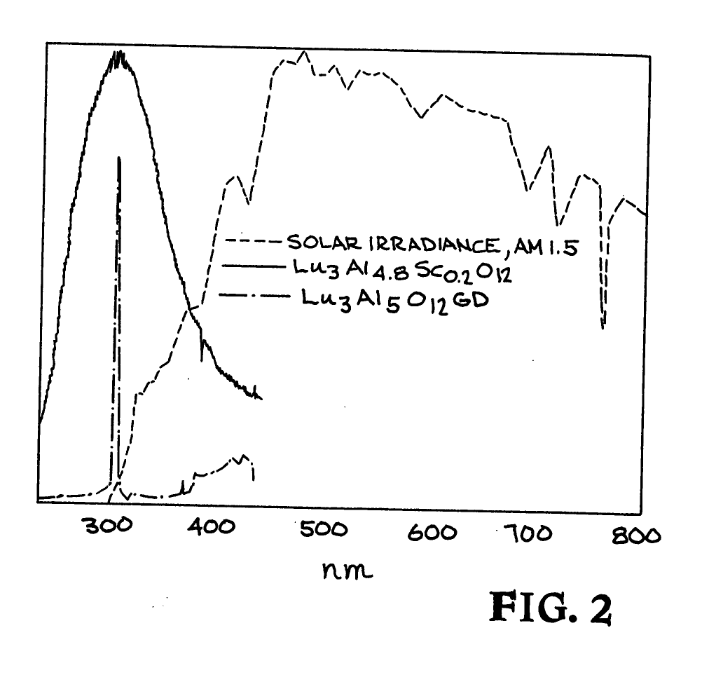

LuAG doped with Scandium is a known scintillator crystal yielding 24,000 photons/MeV in the 230-350 nm range. UV scintillators have advantages in standard scintillation counters, allowing use of wide bandgap semiconductor photodetectors which inherently have lower noise than silicon photodiodes. LuAG:Sc is also known to demonstrate relatively proportional response, giving rise to good energy resolution for scintillation counter applications, on the order of 4-5%, compared to ˜7% for NaI:Tl. Solar irradiance drops by 10-30 orders of magnitude below 300 nm. Optical imaging of scintillation or phosphor emission signals in the presence of sunlight or room lights may be accomplished using a special UV selective viewer such as the viewer 106. This spectral separation dramatically increases signal detection efficiency. FIG. 2 illustrates the radioluminescence spectra of LuAG:Sc and LuAG:Gd, in comparison to the solar spectrum.

Other applications for UV phosphors exist in materials processing and photochemistry that require photons in the energy range 3-5 eV. Crystal growth via transparent ceramic processing allows more uniform doping, homogeneity and potential for larger crystals than single crystal methods. Nanocrystals may be sintered under controlled conditions to form optically transparent polycrystalline scintillator materials. Applicants demonstrate LuAG to be growable as a transparent ceramic, similar to YAG.

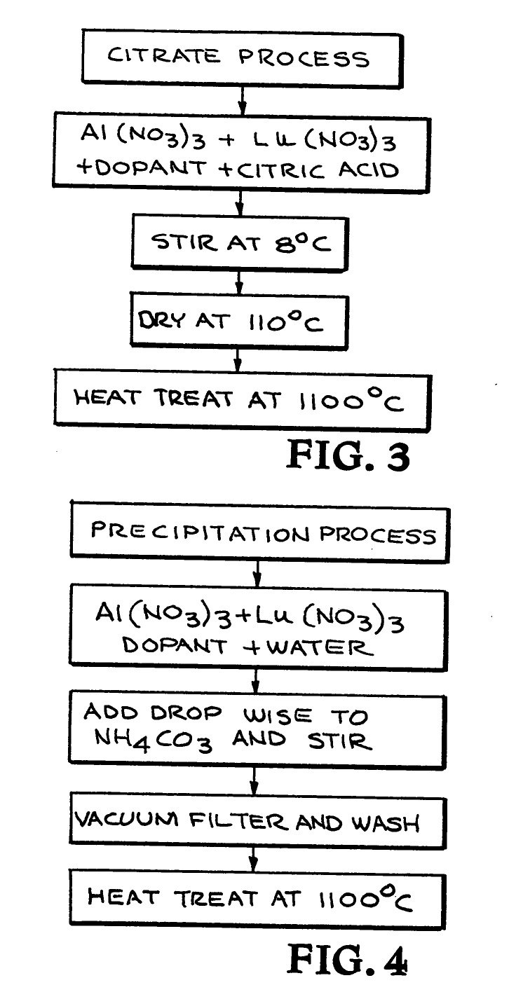

Referring now to FIG. 3 and FIG. 4, flow diagrams show that Lutetium Aluminum Garnet nanocrystals may be synthesized via various synthetic routes. The best known are the citrate and the precipitation methods. The Citrate process is illustrated in the FIG. 3 flow diagram and the Precipitation process is illustrated in FIG. 4 the flow diagram.

The “Citrate process” illustrated in FIG. 3 begins with Al(NO₃₎₃+Lu(NO₃)₃+Dopant+Citric Acid. The next step is to stir at 80° C. The next step is to dry at 110° C. The next step is to heat treat at 1100° C.

The “Precipitation process” illustrated in FIG. 4 begins with Al(NO₃₎₃+Lu(NO₃)₃+Dopant+water. The next step is to add drop wise to NH₄CO₃ and stir. The next step is to vacuum filter and wash. The next step is to heat treat at 1100° C.

The “Citrate process” (FIG. 3) and the “Precipitation process” (FIG. 4) for synthesis of LuAG and LuAG:Gd or Sc use nitrate salts as precursors. The “Citrate process” follows the methods of Vaqueiro, et al. described in P. Vaqueiro, M. A. Lopez-Quintela, “Synthesis of yttrium aluminium garnet by the citrate gel process,” J. Mater. Chem. 8, 161-163 (1998). The disclosure of P. Vaqueiro, M. A. Lopez-Quintela, “Synthesis of yttrium aluminium garnet by the citrate gel process,” J. Mater. Chem. 8, 161-163 (1998) is incorporated herein by reference. Stoichiometric ratios of LuNO₃*XH₂O, Al(NO₃)₃*9H₂O and dopants were mixed together and dissolved in an aqueous citric acid solution. This was heated to 60° C. and stirred for 1-5 hours. Then the mixture was heated in a furnace at 110° C. for 24 hours. The resulting material was heated at 1100° C. (4° C./min ramp) for 4 hours leading to the formation of fully crystalline particles.

For the “Precipitation process” the nitrate salts were dissolved in deionized water and added dropwise to a solution of excess ammonium carbonate under stirring. The resulting precipitate was vacuum filtered and washed with deionized water. The precipitate was heated to 1100° C. (4° C./min ramp) for 4 hours leading to fully crystalline particles.

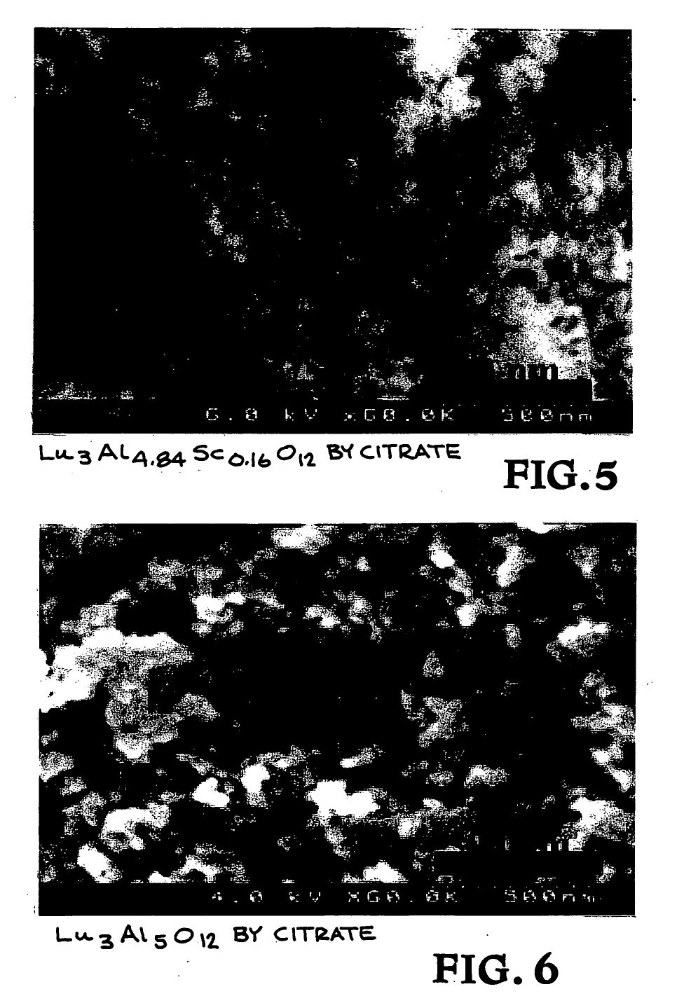

Particles prepared by the citrate process are shown in the SEM images of FIGS. 5 and 6. The SEM micrographs of FIGS. 5 and 6 show that for a given sample prepared using the Citrate method, particle size is quite monodisperse.

Both the doped and undoped LuAG formed homogenous, well dispersed particles approximately 20 to 50 nm in size. Depending on preparation conditions, particle sizes may range from 10-100 nm, but are typically monodisperse, for the citrate preparation method. X-ray diffraction showed that all particles were of the garnet structure.

The addition of small amounts of Scandium to the LuAG modify its scintillation spectrum, greatly enhancing the light yield. Radioluminescence spectra were obtained by preparing thin films of the LuAG nanocrystalline powder in 50/50 blends with a UV-transparent polymer, and exciting scintillation using a ²¹⁰Po alpha source. Light yields were referenced to BaF₂, and the intensity of the Lu₃Al_{4.8}Sc_{0.2}O₁₂ material was found by Applicants to be slightly greater than that of BaF₂. The light yield for BaF₂ under gamma irradiation is ˜10,000 photons/MeV, and is known to be less under alpha excitation. The light yield of the LuAG samples under x-ray excitation (not shown) was also found to be of the order or greater than that of BaF₂. The advantage of the Lu₃Al_{4.8}Sc_{0.2}O₁₂ material is that its scintillation is more fully in the solar blind region, allowing stronger signal enhancement in the specified ‘Solar Blind’ spectral range of 220-290 nm. Doping of the LuAG matrix with Gadolinium gives rise to the characteristic Gd³⁺ line at ˜313 nm. Furthermore, the integrated intensity under the band (under same slit width conditions) is equivalent to that of the best Scandium doped LuAG sample.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A coating for a surface that has an alpha or beta radioactively contaminated area for the detection of alpha or beta radiation from the contaminated area using an UV viewer, comprising:
a coating adapted to be operatively connected to the surface,
phosphor/scintillator particles carried by said coating that causes UV emissions when the alpha or beta radiation from the contaminated area strikes the phosphor/scintillator particles and provides an indication of the alpha or beta radioactively contaminated area, and
an UV viewer for detecting said UV emissions when the alpha or beta radiation from the contaminated area strikes the phosphor/scintillator particles.

2. (canceled)

3. The coating of claim 1 wherein said phosphor/scintillator particles includes garnet UV phosphor or scintillator materials.

4. The coating of claim 1 wherein said phosphor/scintillator particles includes light emitting materials with luminescence in the 200-280 nm range.

5. The coating of claim 1 wherein said phosphor/scintillator particles includes LuAG doped with Scandium.

6. The coating adapted for a surface for the detection of radiological substances, of claim 1 wherein said indicator material includes Barium Fluoride.

7. The coating adapted for a surface for the detection of radiological substances, of claim 1 wherein said indicator material includes Calcium Silicate.

8. The coating adapted for a surface for the detection of radiological substances, of claim 1 wherein said indicator material includes “BAM” (BaMg₂Al₁₆O₂₇:Tl⁺).

9. The coating adapted for a surface for the detection of radiological substances, of claim 1 wherein said indicator material includes Lutetium Aluminum Garnet.

10. A method of detecting radiological substances on a surface, comprising the steps of:
coating the surface with a coating containing an indicator material that produces UV emissions, and
monitoring said coating to detect the radiological substances.

11. The method of detecting radiological substances on a surface of claim 10 wherein said step of coating the surface with a coating containing an indicator material comprises coating the surface with phosphor materials.

12. The method of detecting radiological substances on a surface of claim 10 wherein said step of coating the surface with a coating containing an indicator material comprises coating the surface with scintillator materials.

13. The method of detecting radiological substances on a surface of claim 10 wherein said step of coating the surface with a coating containing an indicator material comprises coating the surface with garnet UV phosphor or scintillator materials.

14. The method of detecting radiological substances on a surface of claim 10 wherein said step of coating the surface with a coating containing LuAG doped with Scandium.

15. The method of detecting radiological substances on a surface of claim 10 wherein said step of coating the surface with a coating containing an indicator material comprises coating the surface with garnet UV phosphor or scintillator materials produced by a citrate process.

16. The method of detecting radiological substances on a surface of claim 10 wherein said step of coating the surface with a coating containing an indicator material comprises coating the surface with garnet UV phosphor or scintillator materials produced by a precipitation process.

17. The method of detecting radiological substances on a surface of claim 10 wherein said step of monitoring said coating to detect the radiological substances comprises monitoring said coating with a solar blind detector.

18. The method of detecting radiological substances on a surface of claim 10 wherein said step of monitoring said coating to detect the radiological substances comprises monitoring said coating with a UV viewer.

19. The method of detecting radiological substances on a surface of claim 10 including the step of recording an optical image of the area of the radiological substances.
